(19) United States
(12) Patent Application Publication
(10) Pub. No.: US 2008/0128577 A1
(43) Pub. Date: Jun. 5, 2008

(54) FORCE ABSORBING BUMPER SUPPORT

(75) Inventors: Jack FIFE, Edmonton (CA); Garvin WEBER, Sherwood Park (CA); Brian SMITH, Leduc (CA)

Correspondence Address: DAVIS BUJOLD & Daniels, P.L.L.C., 112 PLEASANT STREET, CONCORD, NH, 03301, US

(73) Assignee: VENGER GROUP, Leduc (CA)

(21) Appl. No.: 11/948,530

(22) Filed: Nov. 30, 2007

Related U.S. Application Data
(60) Provisional application No. 60/872,104, filed on Dec. 1, 2006.

(51) Int. Cl. F16M 13/00

(52) U.S. Cl. 248/548

(57) ABSTRACT

A bumper support which includes a mounting plate adapted for mounting onto a face of a display case, a bumper retainer carried by the mounting plate and a bumper adapted to engage the bumper retainer. Force transmitting members are supported by the mounting plate and adapted to engage the bumper. Each of the force transmitting members has an upper bumper engaging portion and a lower display case engaging portion. Impacts upon the bumper of sufficient force to cause outward movement of the bumper are transmitted by the upper bumper engaging portion to the lower display case engaging portion, where such impact is diffused along the face of the display case.

### FIELD

The present application relates to a bumper support for absorbing forces applied to the bumper, specifically, a bumper support for bumpers used with display cases.

### BACKGROUND

Bumpers are attached to display cases to protect them against damage caused by impact with shopping carts and delivery dollies.

### SUMMARY

There is provided a bumper support which includes a mounting plate adapted for mounting onto a face of a display case, a bumper retainer carried by the mounting plate and a bumper adapted to engage the bumper retainer. Force transmitting members are supported by the mounting plate and adapted to engage the bumper. Each of the force transmitting members has an upper bumper engaging portion and a lower display case engaging portion. Impacts upon the bumper of sufficient force to cause outward movement of the bumper are transmitted by the upper bumper engaging portion to the lower display case engaging portion, where such impact is diffused along the face of the display case.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of the bumper support supporting a bumper.

FIG. 2 is a perspective view of the bumper support.

FIG. 3 is an end elevation view of the bumper support.

### DETAILED DESCRIPTION

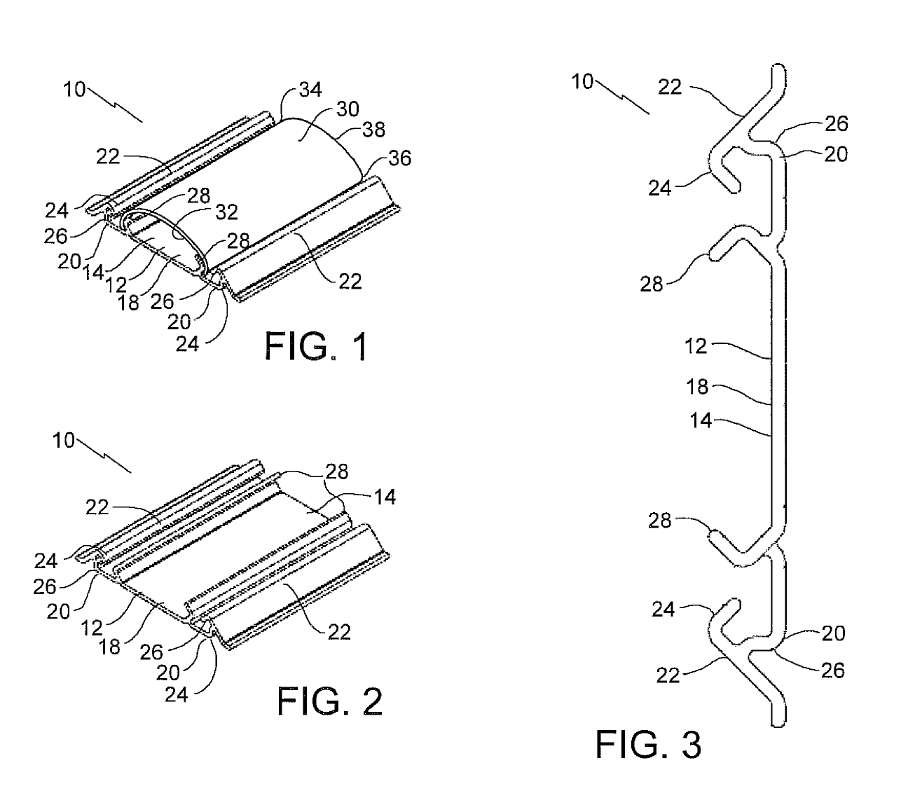

A bumper support generally identified by reference numeral 10, will now be described with reference to FIG. 1 through 3.

Structure and Relationship of Parts:

Referring to FIG. 2, bumper support 10 includes an elongated mounting plate 12 adapted to be mounted onto the face of a display case (not shown). Referring to FIG. 3, mounting plate 12 has a face 18 and opposed edges 20. Force transmitting members 22 are positioned along opposed edges 20 of mounting plate 12. Each the force transmitting members 22 has an upper bumper engaging portion 24, and a lower display case engaging portion 26. Referring to FIG. 1, a bumper retainer 28 made from two depending arms is provided, with a bumper 30 adapted to engage bumper retainer 28. Bumper retainer 28 is shown to be integrally formed with face 14 of mounting plate 12, but it may also be attached to face 14 of mounting plate 12. Bumper retainer 28 retains bumper 30 by engaging an inner surface 32 of bumper 30. Upper bumper engaging portion 24 of force transmitting member 22 is in close contact with bumper 30 to prevent debris from collecting along a first edge 34 or second edge 36 of bumper 30.

Referring still to FIG. 1, first edge 34 and second edge 36 of bumper 30 are connected by a convex portion 38. Convex portion 38 is resilient such that an impact of sufficient magnitude applied to convex portion 38 causes first edge 34 and second edge 36 to move apart in a direction parallel to face 14 of mounting plate 12, and act upon upper bumper engaging portion 24 of force transmitting members 22. The impact is then transmitted by upper bumper engaging portion 24 to lower display case engaging portion 26, where such impact is diffused along the face of the display case.

Operation:

Referring to FIG. 3, elongate mounting plate 12 is mounted onto the face of a display case (not shown), such that the width of face 18 of mounting plate 12 is in a substantially vertical orientation. Bumper retainer 28 may be either integrally formed with face 18, as shown, or attached to face 18 (not shown). Referring to FIG. 1, bumper 30 is installed on mounting plate 12 by engaging the inner surface 32 of bumper 30 using the two arms of bumper retainer 28. Bumper 30 is retained such that first edge 34 and second edge 36 are in close contact with upper bumper engaging portion 24 of force transmitting members 22. When a force is applied to convex portion 38 of bumper 30, such as an impact from a shopping cart, convex portion 38 flexes, such that first edge 34 and second edge 36 move apart in a vertical direction parallel to face 14 of mounting plate 12 against upper bumper engaging portion 24 of force transmitting members 22. The impact is then transmitted by upper bumper engaging portion 24 to lower display case engaging portion 26, where such impact is diffused along the face of the display case. A portion of the force is thus diffused by force transmitting members 22 along the face of the display case, rather than being applied directly to the face of the display case.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A bumper support, comprising:
a mounting plate adapted for mounting onto a face of a display case;
a bumper retainer carried by the mounting plate;
a bumper adapted to engage the bumper retainer;
force transmitting members supported by the mounting plate and adapted to engage the bumper, each of the force transmitting members having an upper bumper engaging portion and a lower display case engaging portion, such that impacts upon the bumper of sufficient force to cause outward movement of the bumper are transmitted by the upper bumper engaging portion to the lower display case engaging portion, where such impact is diffused along the face of the display case.

2. The bumper support of claim 1, wherein the bumper has a first edge and a second edge connected by a convex portion, the convex portion being resilient such that a force applied to the convex portion causes the first edge and the second edge to move apart and exert a force upon the upper bumper engaging portion of the force transmitting members.

3. The bumper support of claim 1, wherein the upper bumper engaging portion of the force transmitting are in close contact with the bumper to prevent debris from collecting along a first edge or a second edge of the bumper.

4. The bumper support of claim 1, wherein the bumper retainer is integrally formed with mounting plate.

5. The bumper support of claim 1, wherein the bumper retainer is attached to a face of the mounting plate.

6. The bumper support of claim 2, wherein the bumper retainer retains the bumper by engaging an inner surface of the bumper.

7. A bumper support, comprising:
an elongated mounting plate adapted for mounting onto a face of a display case, the mounting plate having a face and opposed edges;
force transmitting members positioned along the opposed edges of the mounting plate, each of the force transmitting members having an upper bumper engaging portion, and a lower display case engaging portion;
a bumper retainer on the face of the mounting plate; and
a bumper adapted to engage the bumper retainer, the bumper retainer retaining the bumper by engaging an inner surface of the bumper, the upper bumper engaging portion of the force transmitting members being in close contact with the bumper;
the bumper having convex portion connecting the first edge and the second edge of the bumper, the convex portion being resilient such that such that impacts upon the bumper of sufficient force applied to the convex portion causes the first edge and the second edge to move apart in a direction parallel to the face of the mounting plate and act upon the upper bumper engaging portion of the force transmitting members, the impact being transmitted by the upper bumper engaging portion to the lower display case engaging portion, where such impact is diffused along the face of the display case.
